(19) United States
(12) Patent Application Publication
(10) Pub. No.: US 2011/0295708 A1
(43) Pub. Date: Dec. 1, 2011

(54) SYSTEMS AND METHODS FOR PROVIDING SOFTWARE RENTAL SERVICES TO DEVICES CONNECTED TO A NETWORK

(75) Inventor: Jangwoo Shin, Iansdale, PA (US)

(73) Assignee: beonSoft Inc., Fort Washington, PA (US)

(21) Appl. No.: 12/881,188

(22) Filed: Sep. 14, 2010

Related U.S. Application Data
(60) Provisional application No. 61/347,825, filed on May 25, 2010.

(51) Int. Cl. G06Q 30/00; H04L 9/08

(52) U.S. Cl. 705/26.1; 380/279

(57) ABSTRACT

Methods and computer readable media for providing a rental service for a software application via a network. The user of a device downloads a rental agent application via the network and installs a rental agent application in the device. The user also downloads a software application via the network and installs the software application in the device, where the software application includes a decryption key embedded therein. The user causes the rental agent application to send to a rental system a request for a key to activate the software application via the network. The rental system sends the key to the rental agent via the network, where the key is encrypted with an encryption key that forms an asymmetric key pair with the decryption key. Then, the rental agent relays the key to the software application to thereby activate the software application for a rental period.

### CROSS REFERENCE TO RELATED APPLICATIONS

This application claims the benefit of U.S. Provisional Application No. 61,347,825, entitled “Method and system for software license distribution using asymmetric key cryptography,” filed on May 25, 2010, which is hereby incorporated herein by reference in its entirety.

### BACKGROUND OF THE INVENTION

The present invention relates to software rental systems using a computer network.

Recent development of wireless network and mobile devices poses two unique challenges in providing rental services of software applications using computer networks: (1) sporadic network connectivity due to mobility of computing host in wireless network environment and (2) integration with application storefronts where numerous downloadable applications are made available for purchase or demo.

First, wireless networks relying on radio frequencies do not warrant the constant connectivity traditionally required for authentication and validation of access rights. The technologies discussed in existing prior art depend on always-on or no network as part of their software rental methodology, and thus fail to address characteristics of sporadic network connectivity issue in appropriate terms; i.e., their approach assumes either the software keys are permanently installed or constant network is required for real-time authentication and usage metering.

Second, the existing prior art in software rental methodologies to date failed to efficiently integrate a rental system with existing market fronts because, in one way or another, they disrupt established e-commerce business in software products. In other words, a new methodology is needed to amalgamate a software rental model which can be introduced as an integral part of already established storefronts, without disrupting the existing e-commerce structure of pay-to-own and/or demo applications. This is because established software markets are almost entirely dedicated to dissemination of either for sale or free demo versions of software, where a demo version of software may get upgraded permanently to a full version at payment by installing a permanent key string. Thus, there is a need for an acceptable solution in rental technology that can present a method for publishers to release a unified version of the software that can be activated in rental, demo or for-sale version in the same application storefront.

In addition, existing rental software technologies have not been able to address ‘surrendering/returning’ a rented copy of software for credit, which subsequently resulted in no early-return policy. This key surrendering feature is especially relevant for mobile applications where typical applications achieve simple tasks and their usage is transient. Thus, there is a need for a rental system that can activate/deactivate applications based on the user's need.

### SUMMARY OF THE INVENTION

In one embodiment of the present disclosure, a method and computer readable media are provided for providing a rental service for a software application via a network. The method includes: installing a first application in a device; downloading the software application to the device via the network, the software application including a decryption key embedded therein; causing the first application to send a request for a key via the network; causing the first application to receive the key via the network, the received key being encrypted with an encryption that forms an asymmetric key pair with the decryption key; and activating, by use of the key, the software application for a rental period.

In another embodiment of the present disclosure, a method and computer readable media are provided for providing a rental service for a software application via a network, where software application includes a decryption key embedded therein. The method includes: receiving a request for a key from the device via the network, wherein the key is adapted to activate the software application for a rental period; validating the request; generating the key and encrypting the key with an encryption key that forms an asymmetric key pair with the decryption key; and sending the encrypted key to the device via the network to thereby activate the software application.

These and other features, aspects and advantages of the present invention will become better understood with reference to the following drawings, description and claims.

### BRIEF DESCRIPTION OF THE DRAWINGS

FIG. 1 shows a system environment in accordance with one embodiment of the present invention;

FIG. 2 shows a software architecture of the services provided by the rental system of FIG. 1;

FIG. 3 shows a flow chart illustrating exemplary steps that might be carried out to generate an encrypted key for the application in the user device of FIG. 1;

FIG. 4 shows a flow chart illustrating exemplary steps that might be carried out to activate the application in the user device of FIG. 1;

FIG. 5 shows a flow chart illustrating exemplary steps that might be carried out to authenticate the key for the application in the user device of FIG. 1,

FIG. 6 shows a flow chart illustrating exemplary steps that might be carried out to return the key for the application in the user device of FIG. 1;

FIG. 7 illustrates a typical computer system that may be employed in accordance with the present invention; and

FIG. 8 shows an end user in accordance with another embodiment of the present invention.

### DETAILED DESCRIPTION OF THE INVENTION

Object and/or advantage of one embodiment of the present invention is to provide convenient application rental service to users via a locally installable “rental agent” which integrates necessary rental functions like registration, payment, key chain administration, authentication and security management services as well as search and browse of available rental applications.

Object and/or advantage of another embodiment of the present invention is to provide ready-to-use Application Programming Interface (API) with guidelines and samples to software publishers such that any application can seamlessly be converted to a version that is rent-ready.

Object and/or advantage of another embodiment of the present invention is to provide a method of accessing applications and making payments that are integral to any existing application storefront and e-commerce payment network.

Object and/or advantage of another embodiment of the present invention is to provide light-weight, simple sets of APIs to reduce workload on custom applications by delegating most rental activities to the “rental agent.”

Object and/or advantage of another embodiment of the present invention is to provide seamless operation of rented applications under networks with sporadic connectivity such as mobile networks by implementing key chain delegation functions in association with the “rental agent” application.

Object and/or advantage of another embodiment of the present invention is to provide protection against intellectual property piracy and abuse by introducing key authentication through centrally managed downloadable keys for individual users and devices per each application.

Object and/or advantage of another embodiment of the present invention is to provide an independent service platform that can be transparently applicable for various OS and devices.

Object and/or advantage of another embodiment of the present invention is to provide account management services for rental credits such that users can share with, donate and gift to other subscribers in user groups as desired.

Object and/or advantage of another embodiment of the present invention is to provide a simple method to purchase applications that are previously rented (rent-to-own) by paying extra, possibly at discounted pricing.

Object and/or advantage of another embodiment of the present invention is to provide software publishers with a tool to control and account for the number of copies of their software in circulation for rental usage.

Object and/or advantage of another embodiment of the present invention is to provide a method of advance purchase of credits for rental usage over multiple payment cycles without necessitating key updates for extended periods.

Object and/or advantage of another embodiment of the present invention is to provide the ability to remotely enforce expiration of applications installed on lost or stolen devices by pushing orders of invalidating appropriately tagged keys to rental agent application.

Object and/or advantage of another embodiment of the present invention is to provide functions to transfer credits installed on one device to another, in case of computing device upgrade or ownership change.

Object and/or advantage of another embodiment of the present invention is to provide a platform for publishers to seamlessly add rental service as an integral part of existing application storefront services while introducing application rental service that will not interfere with existing lines of business in offering the same application for-sale or demo use.

Object and/or advantage of another embodiment of the present invention is to provide extensive search and browsing functionalities for subscribers and publishers such that users can make better purchase decisions and publishers can promptly respond to market needs.

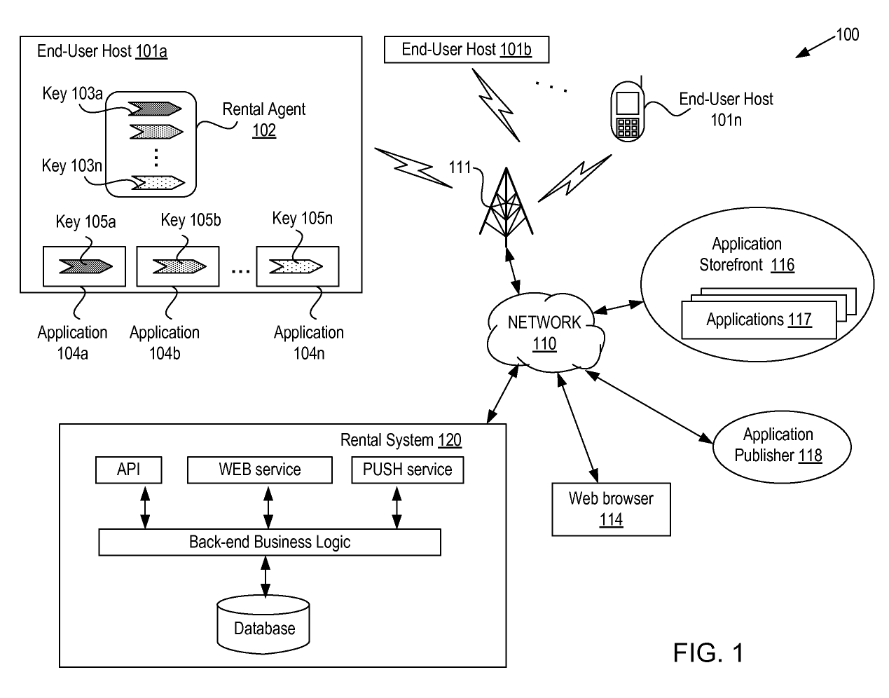

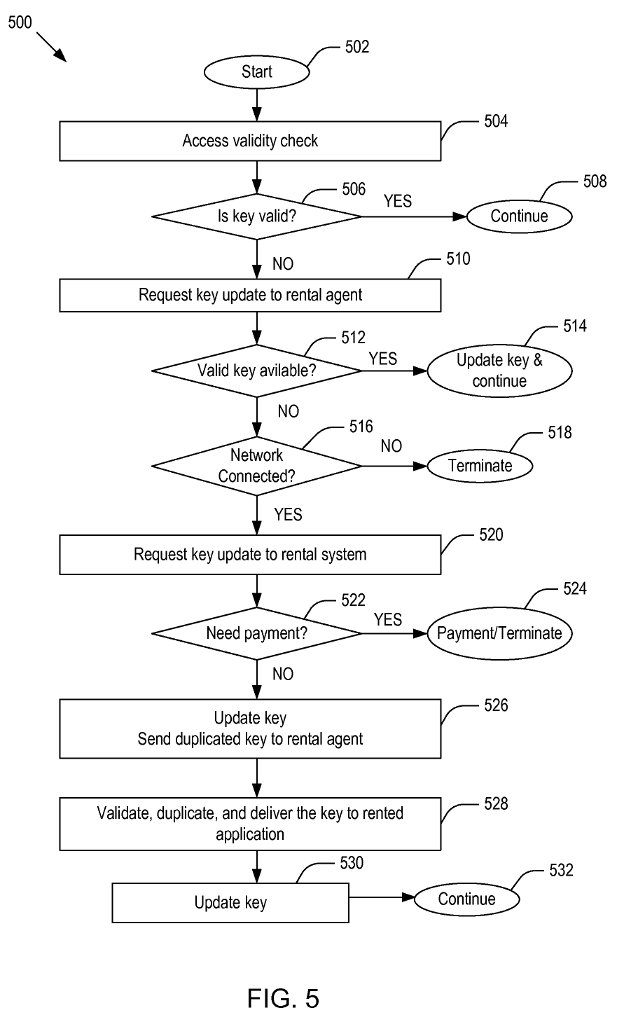

Referring now to FIG. 1, there is shown at 100 a schematic diagram of a system environment in accordance with one embodiment of the present invention. As depicted, an application storefront 116 and the rental system 120 communicate to the end-user hosts (or, equivalently user devices) 101a-101n via a network 110. The application publisher 118, which may be connected to the network 110, develops software applications and registers its rent-ready software applications 117 onto the application storefront 116. The applications 117 are available for download to the user devices 101 via the network 110, but the versions available for download come with limitations in terms of duration or number of usage and/or available features. Such limitations can be lifted either in part or full by purchasing and applying credits and by installing authentication keys 105a-105n for the applications 104a-104n. (Here, the applications 104 are copies of the applications 117.) The key is a software license and, hereinafter, the terms key, license file, license key, activation key, and control vector are used interchangeably since they contain an encrypted version of license. Also, the terms license and rental are used interchangeably since renting a software application is getting a license under a set of present terms. Detailed description of the process for generating the authentication key is given in conjunction with FIG. 5. It is noted that the user of each device 101 may download as many rent-ready applications 117 as possible as his device supports without requiring any of them be activated unless their needs for use arise.

The application publisher (or, shortly publisher) 118 accesses and manages its account of the rental system 120 through any web browser 114 (or a management program offered from rental system optionally). It is noted that the web browser 114 may be physically located in any suitable computer connected to the network 110. It is also noted that the publisher 118 may manage the application storefront 116. It is further noted that the publisher refers to not only a person (or entity) who prepares the applications 104 but also a person (or entity) who gives a license for using the applications, i.e., the publisher can be a software licensor.

The network 110 may be a broadband public network, such as the Internet, or any other suitable local network. Unlike the existing systems, the operation of the rental system 100 does not require the network 110 guarantee a stable and continuous network connection between the rental system 120 and the user devices 101a-101n, i.e., the connection can be sporadic.

Each of the user devices 101a-101n may be any suitable device having capabilities to run one or more applications 104 therein and to communicate via the network 110. The user devices 101a-101n may be, but not limited to, portable devices, such as cellular phones or PDAs and communicate wirelessly via a wireless carrier 111 connected to the network 110. A rental agent application (or, shortly rental agent) 102 installed in each of the devices 101 may search for applications 117 on the storefront 116 so that the user of the device 101 can shop applications 117 from the application storefront 116. The users may purchase and/or download for free one or more applications onto their devices 101. Some of the rentable applications 104 can be downloaded directly to the devices 101 from marketplace and/or dedicated download site, such as the application storefront 116, at no cost. Immediately after the download and installation in the devices 101, each rentable application 104 is set to either locked or demo (trial) mode which is typically set to ‘limited usage’.

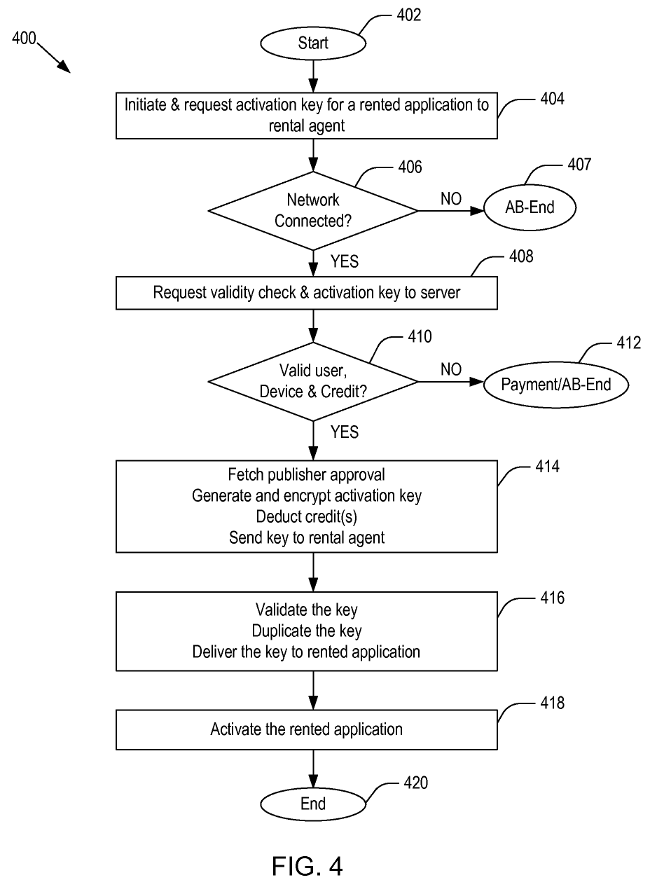

If any of the applications, say 104a, is rent-ready, the application 104a will not run without the license key 105a. Thus, to run the application in the device 101, the user of the device needs to acquire a corresponding activation key (or, equivalently, license key) 105a and plug the key into the application 104a, where the key 105a is issued by the rental system 120 in association with the application publisher 118 after verification steps. Detailed description of the verification steps is given in conjunction with FIGS. 4-5.

Each user of the user devices 101 can download the rental agent 102 from the application storefront 116 and run the rental agent during operation of the applications 104. The rental agent 102 residing on the device 100 plays a primary role between the applications 104 and the rental system 120 as a control tower of the overall process. The major functions of the rental agent 102 includes, but is not limited to, verifying its host device 101, managing security and profiles, rental accounts, and validity, requesting the keys 105 to the rental system 120, receiving the keys, delivering duplicate copies of the keys 105 to the applications 104, and securing newest keys in a keychain. The rental agent 102 may keep keys 103 that are copies of the keys 105 or updated versions of the keys 105. Users of the devices 101 manage their rental accounts through the rental agents 102 or web browsers connected to the network 110.

It is noted that the rental system 120 transmits a time-stamp each time it interacts with the individual device 101. The time-stamp received by the rental agent 102 is locally secured by the rental agent 102 to be utilized for checking expiration of the keys 105.

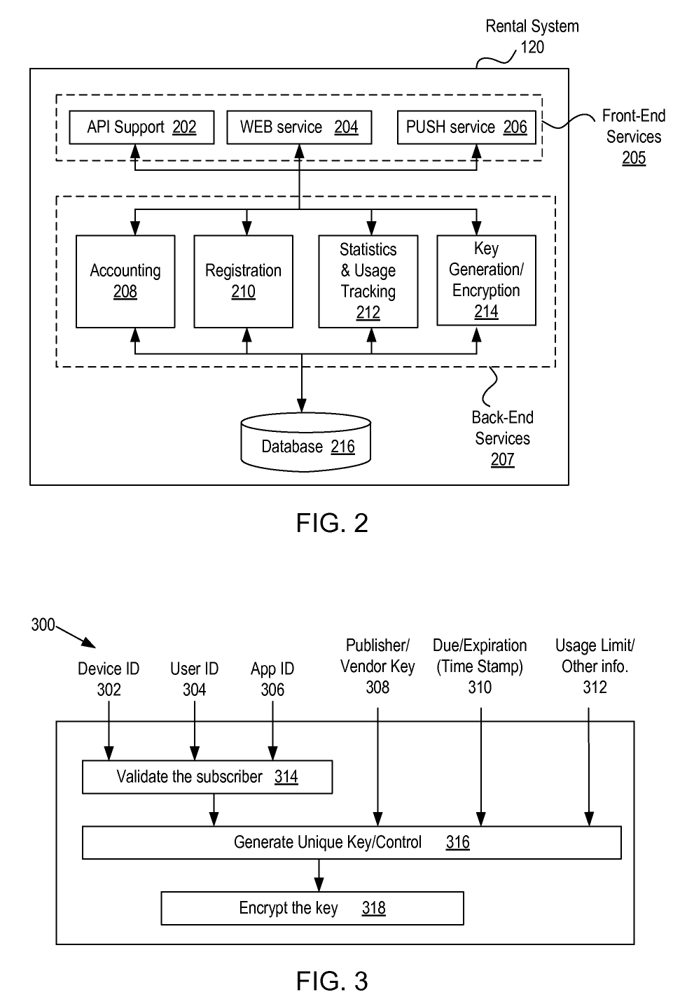

FIG. 2 shows a software architecture of the services provided by the rental system 120 of FIG. 1. As depicted, the front-end services 205 of the rental system 120, which securely interface external entities, include an API support module 202, a WEB service module 204, and a PUSH service module 206, while the back-end services 207, which implement actual rental business service, include an accounting module 208, a registration module 210, a statistics & usage tracking module 212, and a key generation/encryption module 214.

The API support module 202 serves the rental agent 102, where an API may be a software program, such as a function call, offered to the application publisher 118 so that the publisher can generate rental versions of the applications 117 using the API. For instance, the application publisher 118 may embed the API in the rental versions of the applications 117, i.e., the publisher 118 uses the API to impose a limitation in terms of duration or number of usage and/or available features. In other words, the API enables the publisher 118 to control the limitations imposed on the versions of the applications 117. The communication between the device 101 and the rental system 120 is realized by API communications. For instance, when the user requests a license key for an application, say 104a, the API embedded in the application 104a makes one or more function calls carrying information of the application 104a and the device 101. Then, the rental agent 102 relays the function calls to the rental system 120, and the API support module 202 responds to the calls to thereby extract the information. The publisher 118 may install a set of APIs at strategic locations of the applications 104 to verify rental credit and payment status of the user of the applications 104 using the keys 105 transferred by the rental system 120.

The WEB service module 204 serves web pages that allow both the users of the devices 101 and publishers 118 to communicate information to the rental system 120, even though accessible web contents might be different for each party. For instance, a web page for the users of the devices 101 may provide information of the rent-ready applications supported by the rental system 120, while a web page for the publisher 118 may provide information of APIs available to the publisher. The users of the devices 101 and/or the publisher 118 may access the webpage of the rental system 120 to browse/rate applications for rental, access user logs, check application rental statistics or access other information featured in the rental system 120.

The PUSH service module 206 plays an important role for key chain management at the rental agent 102 which supports local key delegation functions under sporadic network connection. The rental system 120 may have notifications/messages to be sent to the devices 101, such as expiration dates of the keys 105. The rental system 120 may also enforce expirations of applications 105 installed on a lost/stolen device by sending invalidation keys to the rental agent 102. The PUSH service module 206 manages and sends the messages and/or invalidation keys in an asynchronous manner such that the users of the devices 101 may receive and respond to the messages on their own schedules.

As discussed above, the rental agent 102 can be downloaded from a mobile application marketplace or application storefront 116. Upon downloading the rental agent, the following steps are executed for registration of membership: (i) at initiation, the rental agent 102 investigates the device 101 and collects information necessary for the registration process, such as device type, application marketplace login, payment info, authentication data for encryption and identification, membership type, etc. (ii) The rental agent 102 sends a registration request to the rental system 120 over the network. (iii) The registration service module 210 of the rental system 120 processes the received registration request and issues an approval with a necessary certificate.

Some of the applications 104 in the devices 101 are rentable applications that the users of the devices need to pay for the applications to the publisher 118. The accounting module 208 manages the financial information of the user devices 101 and the application publisher 118 who created the rented applications 104. For instance, each payment by the user of the device 101 is processed at the beginning of each billing period by the accounting module 208 and prepayment is offered optionally to issue keys valid for longer expiration for extended usage cycles. In each billing period, the user of the device 101 may elect to pay and continue the membership. At the time of each payment, a renewed key for each application currently rented out will be delivered to rental agent 102 via the network 110. For accounts that are set to automatic renewal, keys are pushed to the rental agent 102 upon payment authorization by the accounting module 208.

The statistics & usage tracking module 212 keeps track of various statistical information associated with each application 104, such as the number of downloads and current users, usage hour, etc. The usage statistics are made available to the publisher 118 to assist their business decision processes and to users of the devices 101 to assist their rental decisions. The key generation/encryption module 214 generates keys 105 that are required to activate the applications 104 and controls encryption of the applications 117. Detailed description of the key generation and encryption module 214 is given in conjunction with FIG. 3.

FIG. 3 shows a flow chart 300 illustrating exemplary steps that might be carried out to generate a key, say 105a, for the application 104a installed in the user device 101. Upon receiving a request for a key from the applications 104, the rental agent 102 residing in each device 101 requests the key to the rental system 120 for a rental application 104 by sending the request with subscriber information that includes device ID 302, a subscriber/user ID (account ID) 304, and the unique ID 306 for each application. Then, the service modules in the rental system 120 validates the subscriber information sent by the rental agent 102 in a state 314. For example, the accounting module 208 checks the remaining balance in the user account. In another example, the registration module 210 may check if the device 101 is registered. Upon validation, the key generation/encryption module 214 generates an encrypted key with additional information, such as publisher/vendor key 308 (which is an encryption key generated by the publisher 118), time-stamp 310, due date, version number, and other restrictions controlling usage limitations 312, in a state 316. The information 308-312 may be retrieved from the database 216 or received from the publisher 118. Then, in a state 318, the key is encrypted by the key generation/encryption module 214 and sent to the rental agent 102 via the network 110.

The publisher 118 creates an asymmetric key-pair having an encryption key and a decryption key. Then, the publisher 118 embeds the decryption key in the applications 117 and releases the applications to the storefront 116 while keeping the encryption key (or, equivalently, the public/vender key 308) as secret. When the key generation/encryption module 214 generates the key in the state 318, the key is encrypted using the encryption key received from the publisher 118. A detailed description of the cryptography associated with the applications 104 and keys 105 is disclosed in a copending U.S. patent application Ser. No. ______, entitled “methods and systems for software license distribution using asymmetric key cryptography,” filed on Sep. 14, 2010, which is hereby incorporate herein by reference in its entirety.

FIG. 4 shows a flow chart 400 illustrating exemplary steps that might be carried out to activate the applications 104 in the user device 101. The process to activate the applications 104 that reside in the device 101 and have not been activated begins in a state 402. In a state 404, the user of an application, say 104a, requests the key 105a to the rental agent 102, where the key 105a is a license key required to unlock the application 104a. The request may be realized by causing the user to initiate the request on the GUI display of the application 104a, for example. Then, the API embedded in the application 104a may send the request to the rental agent 102. In an alternative embodiment, the user may initiate the request directly from the rental agent, even under the absence of the application 104a. For example, the user may initiate the request on the GUI display of the rental agent 102. Then, the user may download the application 104a later and run the application 104a using the key 105a downloaded in advance.

Next, in a decision block 406, the rental agent 102 determines whether the network 110 is connected to the device 101. If the network connectivity is not available, the process ends abnormally in a state 407. Otherwise, the process advances to a state 408.

In the state 408, the rental agent 102 sends a request for an activation key and validity check of various items to the rental system 120, where the items include user, device, and application information as well as user accounts/credits. In one embodiment, the rental agent 102 may send the request with a time stamp, where the request may be realized by API communications. Then, the rental system 120 may receive the request and perform the requested validity check in a decision block 410. Optionally, the rental agent 102 may validate some of the items, such as the user and device, included in the request. If the rental system 120 determines that at least one of the items is invalid, the process terminates in the state 412. Otherwise, the process advances to a state 414. It is noted that the rental system 120 may allow the process to proceed to the state 414 even though one or more of the validation items are not satisfied in the decision block 410. For instance, the user account may not have sufficient credit to issue the key 105a. In such a case, the rental system 120 may allow the user to replenish the balance before proceeding to the state 414. The user may use the device 101 to make a payment, cancel the account, or browse subscriber and rental information provided by the rental agent 102.

In the state 414, the rental system 120 may fetch publisher's approval for issuing the key, if necessary. For example, the rental system 120 may request the publisher 118 send the publisher/vendor key 308 and/or the usage limitation 312 (shown in FIG. 3). In another example, the publisher 118 may delegate to the rental system 120 the authority to issue the key. In such a case, the publisher/vendor key 308 may be retrieved from the database 216 or generated by the rental system 120. Then, the rental system 120 generates the activation key (or, equivalently, the license key or rental key) 105a that is valid for the duration of remaining billing period, encrypt the activation key with the publisher/vendor key 308, and sends the encrypted key to the rental agent 102. Also, credit for the rental is deducted from the user account in the state 414. Next, in a state 416, the rental agent 102 validates the encrypted key received from the rental system 120 first, duplicates the key, sends one copy 105a to the rented application 104a, and stores the other 103a in the secured location (or, equivalently, key chain) by direct push. Next, in a state 418, the rented application 104a unlocks itself with the key 105a and continues its process in the device 101 for a rental period, i.e., the key 105a activates (or equivalently, unlock) the application 104a for rental usage. Then, the process terminates in a state 420.

It is noted that the keys 105 remain encrypted in any transit between components in FIG. 1 (for instance, between the rental agent 102 and the applications 104) and storage medium (such as physical storages for the rental agent 102 and the applications 104) to warrant security and are decrypted for use in the corresponding applications 104 on-the-fly while execution of the applications as needed.

FIG. 5 shows a flow chart 500 illustrating exemplary steps that might be carried out to authenticate the key, say 105b, in the course of execution of the application, say 104b, in the user device 101. The validity of the key 105b may be checked at each new invocation of the application 104b or strategic points in execution, such as context switching where the application 104b enters READY-RUN status form SLEEP in the OS dispatcher. The strategic points might be determined by the publisher's discretion, typically at READY-RUN context switches. The process to authenticate the key 105b in the course of execution in already activated application 104b starts in a state 502. In a state 504, the application 104b executes local validity check for the key 105b in possession. In a decision block 506, the application 104b may access a locally cached key to determine whether the current key 105b is valid. If the current key 105b inside the application 104b is valid, the application continues to the normal execution in a state 508. Upon negative answer to the decision block 506, the application 104b sends a request for an updated key to the rental agent in a state 510. The procedure for sending the request in the state 510 is similar to that in the state 404, i.e., API communication is used to send the request. Then, the process advances to a decision block 512.

In the block 512, the rental agent 102 accesses a key chain, fetches the corresponding key 103b from the key chain, and determines whether the fetched key is valid. More specifically, the rental agent 102 checks the validity and integrity of the fetched key to determine if the fetched key is an updated key. If the rental agent 102 owns an updated key already received from the PUSH service module 206 of the rental system 120, the rented application 104b replaces the old key with the new one so that the application 104b contains the updated key, and continues to the normal execution path in a state 514. If the key 103b is the same as the key 105b, i.e., the key 103b is outdated as the key 105b, the process advances to a decision block 516.

In the block 516, the rental agent 102 determines whether the device 101a is connected to the network 110. If the network is not connected, the process terminates in a state 518. Otherwise, the process advances to a state 520. In the state 520, the rental agent 120 requests the rental system 120 issue a new key, where the request may be realized by API communications. Then, the rental system 120 determines whether the user account has a balance sufficient to issue a new key in a decision block 522. If the answer to the decision block 522 is positive, the rental system 120 may terminate the process in a state 524. Or, as an option, the renal system 120 may proceed with limited leniency or request the user to replenish the balance (i.e., renew the membership) and the process proceeds to a state 526. Upon negative answer to the decision block 522, the process proceeds to the state 526.

In the state 526, the rental system 120 performs similar steps as in the state 414, i.e., it fetches the publisher's approval (if necessary), update and encrypt the key, deduct the credit, and send (push-sync, if available) the key to the rental agent 102. Then, in a state 528, the rental agent 102 performs similar steps as in the state 416, in that it validates the key received from the rental system 120 first, duplicates the key, sends one copy 105b to the rented application 104b, and stores the other 103b in the secured location (or, equivalently, key chain). Next, in states 530 and 532, the rented application updates the key and continues the normal operation. It is noted that the user of the device 101 may purchase credits for rental usage of the application 104n over multiple payment cycles without necessitating key updates described in the flow chart 500.

The user device 101 may be inaccessible due to unexpected events, such as being lost, broken, or travelling. The rental system 120 may send alert notifications to the inaccessible user devices via push sync-up at predetermined times, and put the user's account on hold. When a request for stop-payment is sent by the user of the device 101, rental system 120 may also put the user's account on hold. When the account is put on hold, the rental system 120 may push invalid keys to the rental agent 102 to force expiration of the applications 105.

The user may purchase the rented applications at a discount for permanent user (rent-to-own). The steps for purchasing a key for permanent use would be similar to those in the flow chart 500. As such, the steps are discussed briefly. The user may initiate the purchase process by sending a purchase request of an application to the rental agent 102. Then, the rental agent 102 checks if the network 110 is connected. If the network 110 is not connected, the process terminates. Otherwise, the rental agent 102 sends the request to the rental system 120. Next, the rental system 120 may check the credit in the user account, generate a key for permanent use, deduct the credit, and send the key to the rental agent 102, where the key is encrypted with encryption key. Finally, the rental agent 102 may copy of the key for permanent use, keep one copy in the key chain, and deliver the other copy to the application so that the user can use the application without further payment.

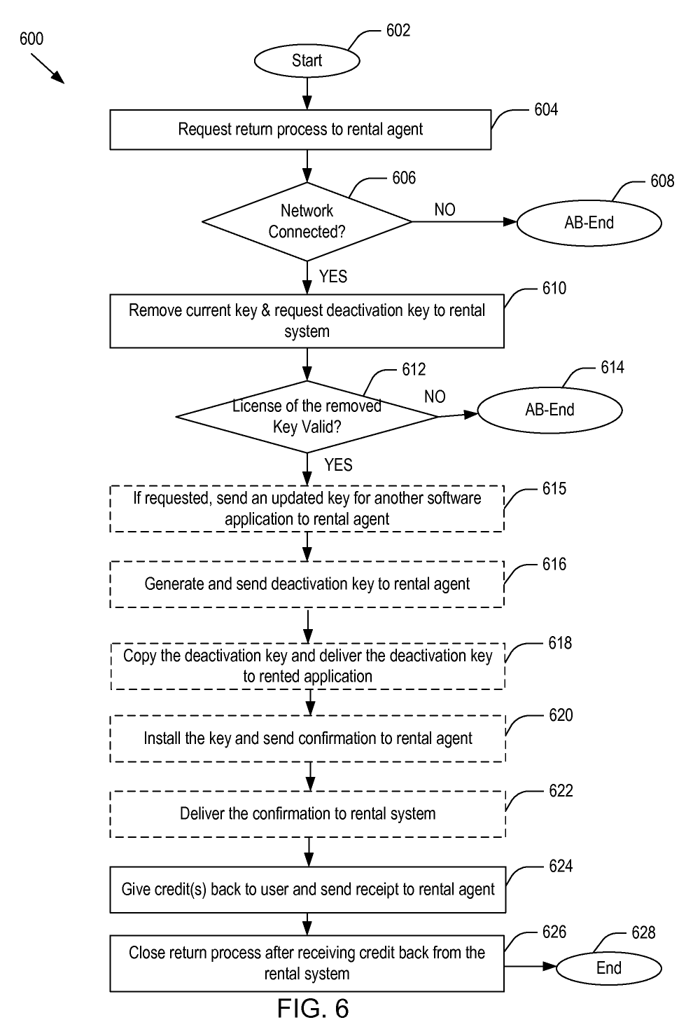

Unlike existing conventional systems, one embodiment of the present invention allows the user to redeem credit by returning valid keys. FIG. 6 shows a flow chart 600 illustrating exemplary steps that might be carried out to return the key 105 for each application 104 in the user device 101. The user of the device 101 is allowed to surrender only valid keys, i.e., the keys having unexpired licenses. The expiration may be based on time and duration of usage and/or execution of features of applications 104 as designated by publishers 118. The process starts in a state 602. In a state 604, the user of the device 101 triggers return process from the application, say 104n, so that the application sends the request to the rental agent 102. The device 101 may use API applications to send the request.

As an option, the user may exchange/swap the license of the returned key into another license for a designated application. In such a case, the user may send a request for an updated key for the designated application as well as the request for surrendering the key in the state 604. Then, the process proceeds to a decision block 606.

In the decision block 606, the rental agent 102 determines whether the network 110 is connected to the device 101. Upon negative answer to the decision block 606, the process abnormally terminates in a state 608. Otherwise, the process proceeds to the state 610.

In the state 610, the application 104n, more specifically the API embedded in the application 104n, securely removes the current key 105n from the storage medium where the application accesses, to thereby nullifying the license of the key and make it impossible for further use of the key 105n. Then, the rental agent requests a deactivation key to the rental system 120. Then, in a decision block 612, the rental system 120 determines whether the license of the removed key is still valid, i.e., the license of the removed key is still effective. If the answer to the decision block is negative, the process terminates in a state 614. Otherwise, the process may take optional steps 615-624.

As discussed above, the user may want to exchange the valid license of the removed key with an updated key for another application. In such a case, the rental system 120 may generate an updated key and send a duplicated key to the rental agent in the state 615. Since the process to generate and use the updated key is similar to the process described in FIG. 5, detailed description of the process is not repeated.

In a state 616, the rental system generates and sends a deactivation key to the rental agent 102, where the deactivation key is used to invalidate further use of the application 104n. Then, in a state 618, the rental agent 102 copies the deactivation key and delivers one copy to the rented application 104n while the other copy is kept in the key chain. Next, the application 104n installs the key to deactivate itself and sends confirmation of deactivation to the rental agent 102 in a state 620. Subsequently, the rental agent 102 delivers the confirmation message to the rental system 120 to post the user credits back on to the user account in a state 622. Then, the process proceeds to a state 624.

In the state 624, the accounting module 208 of the rental system 120 gives credit back to the user of the device 101 and sends a receipt to the rental agent 102. Next, the rental agent 102 closes the return process right after receiving the receipt of the credit-back from the rental system 120 in a state 626. Then, the process terminates in a state 628.

It is noted that the user may share with, donate, and gift the redeemed rental credit to other subscribers in a user group as desired. Also, as discussed above, the user may want to exchange the valid license of the removed key with an updated key for another application. In such a case, the credit returned to the user in the step 624 may be reduced by the amount spent to generate the updated key for another application.

It is noted again that the states 615-622 are optional, i.e., the process may proceed from the decision block 612 to the state 624 when the answer to the decision block 612 is positive. The application publisher 118 may use his discretion to determine whether the states 615-622 are optional.

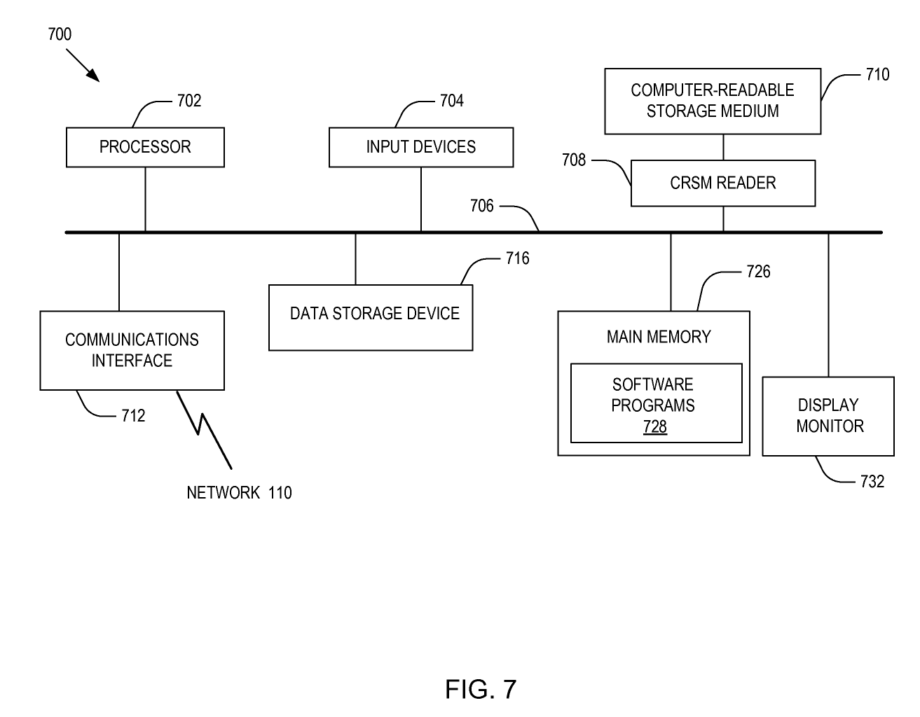

FIG. 7 is a schematic diagram of a typical computer system shown at 700 that may be employed in accordance with the present invention. Depending on its configuration, the computer system may be employed as a desktop computer, a server computer, or an appliance, for example and may have less or more components to meet the needs of a particular application. As illustrated, the computer system may include a processor 702, such as those from the Intel Corporation or Advanced Micro Devices, for example. The computer system may have one or more buses 706 coupling its various components. The computer system may also include one or more input devices 704 (e.g., keyboard, mouse), a computer-readable storage medium (CRSM) 710, a CRSM reader 708 (e.g., floppy drive, CD-ROM or DVD drive), a display monitor 732 (e.g., cathode ray tube, flat panel display), a communication interface 712 (e.g., network adapter, modem) for coupling to a network, one or more data storage devices 716 (e.g., hard disk drive, optical drive, FLASH memory), and a main memory 726 (e.g., RAM). Software programs 728, such as various modules of the rental system 120, may be stored in the computer-readable storage medium 710 and read into the data storage devices 716 or main memory 726 as illustrated in FIG. 7. Likewise, the database 216 may be stored in CRMS 710 and read into the data storage 716 or main memory 726.

The computer 700 may used to implement one or more of the rental system 120, the application storefront 116, or application publisher 118. As one of ordinary skill in the programming art can implement without undue experimentation the software programs 728, a detailed description as to the implementation of the software programs 728 is not given in the present document. It is also noted that those of ordinary skill can implement various software programs without undue experimentation that can carry out one or more steps in the processes 300, 400, 500, and 600.

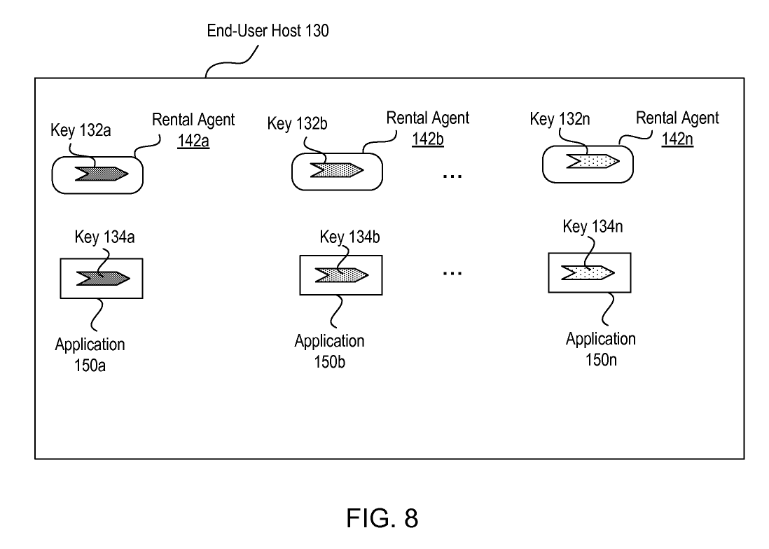

FIG. 8 shows an end user in accordance with another embodiment of the present invention. As depicted, the end-user host 130 includes one or more rental agents 142a-142n having keys 132a-132n and one or more applications 150a-150n having keys 134a-134n, where each of the rental agents is associated with a corresponding application. When the user of the host 130 downloads an application, say 150a, via the network 110, the rental agent 142a implemented in the application 150a as an API program is automatically installed in the host.

Each of the rental agents 142a-142n performs the same functions as the rental agent 102 (FIG. 1), with the difference that each of the rental agents performs functions associated with only one application. For instance, the rental agent 142b plays a primary role between the application 150b and the rental system 120 as a control tower of the overall process. The major functions of the rental agent 142b includes, but is not limited to, verifying its host device 101, managing security and profiles, rental accounts, and validity, requesting the key 134b to the rental system 120, receiving the key, delivering a duplicate copy of the key 134b to the application 150b, and securing the newest key in a keychain. The rental agent 142b may keep a key 132b that is a copy of the key 134b or updated versions of the key 134b. The user of the device 130 manages its rental accounts through the rental agents 142a-142n or web browsers connected to the network 110.

It will be appreciated by those of the ordinary skill that the illustrated process may be modified in a variety of ways without departing from the spirit and scope of the present invention. For example, various portions of the processes illustrated in FIGS. 3-6 may be combined, rearranged in an alternate sequence, be removed, and the like. In addition, it should be noted that the process may be performed in a variety of ways, such as by software executing in a general-purpose computer, by firmware and/or computer readable medium executed by a microprocessor, by dedicated hardware, and the like.

It should be understood, of course, that the foregoing relates to exemplary embodiments of the invention and that modifications may be made without departing from the spirit and scope of the invention as set forth in the following claims.

What is claimed is:

1. A method for providing a rental service for a software application via a network, comprising:
installing a first application in a device;
downloading the software application to the device via the network, the software application including a decryption key embedded therein;
causing the first application to send a request for a key via the network;
causing the first application to receive the key via the network, the received key being encrypted with an encryption that forms an asymmetric key pair with the decryption key; and
activating, by use of the key, the software application for a rental period.

2. The method as recited in claim 1, wherein the step of installing includes downloading the first application to the device via the network.

3. The method as recited in claim 1, further comprising, prior to the step of causing the first application to send a request:
causing the software application to send the request to the first application.

4. The method as recited in claim 3, further comprising, prior to the step of causing the first application to send a request:
validating the request sent by the software application.

5. The method as recited in claim 1, further comprising, prior to the step of activating the software application:
causing the first application to validate the key;
causing the first application to duplicate the key; and
causing the first application to deliver the key to the software application.

6. The method as recited in claim 1, further comprising:
causing the first application to send a request for an updated key via the network;
causing the first application to receive an updated key via the network; and
activating, by use of the updated key, the software application for another rental period.

7. The method as recited in claim 6, further comprising, prior to the step of causing the first application to send a request for an updated key:
causing the software application to send the request for an updated key to the first application.

8. The method as recited in claim 7, wherein the software application includes at least one Application Program Interface (API) and the step of causing the software application to send the request for an updated key includes:
causing the API to make a call; and
sending the call to the first application.

9. The method as recited in claim 6, further comprising, prior to the step of causing the first application to send a request for an update key:
validating the request for an update key sent by the software application.

10. The method as recited in claim 1, further comprising, prior to the step of activating the software application for another rental period:
causing the first application to duplicate the updated key; and
causing the first application to deliver the updated key to the software application.

11. The method as recited in claim 1, further comprising:
causing the software application to remove the key;
causing the first application to send a request for a deactivation key via the network; and
causing a user of the device to receive credit for removing the key.

12. The method as recited in claim 11, further comprising, prior to the step of causing the first application to send a request for a deactivation key:
causing the software application to send the request for the deactivation key to the first application.

13. The method as recited in claim 11, further comprising, prior to the step of deactivating the software application:
causing the first application to receive a deactivation key; and
causing the first application to duplicate the deactivation key,
wherein the software application is deactivated by installing the deactivation key into the software application.

14. The method as recited in claim 13, further comprising, after the step of deactivating the software application
sending a confirmation of the installation of the deactivation key to the first application;
causing the first application to send the confirmation via the network; and
causing the first application to receive a receipt for credit given back to a user of the device via the network.

15. The method as recited in claim 1, wherein the network is sporadically connected.

16. The method as recited in claim 11, further comprising:
downloading an additional software application to the device via the network;
causing the first application to send a request for an additional key to activate the additional software application;
causing the first application to receive the additional key via the network; and
activating, by use of the additional key, the additional software application for a rental period,
wherein the credit is reduced by an amount spent to generate the additional key

17. A method for providing a rental service for a software application in a device via a network, wherein the software application includes a decryption key embedded therein, the method comprising:
receiving a request for a key from the device via the network, wherein the key is adapted to run the software application;
validating the request;
generating the key and encrypting the key with an encryption key that forms an asymmetric key pair with the decryption key; and
sending the encrypted key to the device via the network to thereby run the software application.

18. The method as recited in claim 17, wherein the step of validating the request includes:
checking a credit of a user of the device; and
causing the user to pay when the credit is not sufficient to generate the key.

19. The method as recited in claim 18, further comprising, prior to the step of generating the key:
deducting the credit by an amount commensurate with the key.

20. The method as recited in claim 17, further comprising:
causing the software application to remove the key;
checking whether a license of the removed key is valid; and
giving a credit back to a user of the device for removing the key.

21. The method as recited in claim 20, further comprising, prior to the step of giving a credit:
generating a deactivation key to deactivate the software application;
sending the deactivation key to the device via the network; and
receiving a confirmation of deactivating the software application from the device via the network.

22. The method as recited in claim 20, further comprising:
receiving a request for an additional key from the device via the network, wherein the additional key is adapted to run an additional software application in the device; and
sending the additional key to the first application,
wherein the credit is reduced by an amount spent to generate the additional key.

23. The method as recited in claim 17, wherein the network is sporadically connected.

24. A computer readable medium carrying one or more sequences of pattern data for providing a rental service for a software application via a network, wherein execution of one or more sequences of pattern data by one or more processors causes the one or more processors to perform the steps of:
installing a first application in a device;
downloading the software application to the device via the network, the software application including a decryption key embedded therein;
causing the first application to send a request for a key via the network;
causing the first application to receive the key via the network, the received key being encrypted with an encryption that forms an asymmetric key pair with the decryption key; and
activating, by use of the key, the software application for a rental period.

25. A computer medium as recited in claim 24, wherein execution of one or more sequences of pattern data by one or more processors causes the one or more processors to perform the additional steps of:
causing the software application to remove the key;
causing the first application to send a request for a deactivation key via the network; and
causing a user of the device to receive credit for removing the key.

26. A computer medium as recited in claim 25, wherein execution of one or more sequences of pattern data by one or more processors causes the one or more processors to perform the additional steps of:
causing the first application to receive a deactivation key; and
causing the first application to duplicate the deactivation key,
wherein the software application is deactivated by installing the deactivation key into the software application.

27. A computer readable medium carrying one or more sequences of pattern data for providing a rental service for a software application via a network, wherein the software application includes a decryption key embedded therein and wherein execution of one or more sequences of pattern data by one or more processors causes the one or more processors to perform the steps of:
receiving a request for a key from the device via the network, wherein the key is adapted to activate the software application for a rental period;
validating the request;
generating the key and encrypting the key with an encryption key that forms an asymmetric key pair with the decryption key; and
sending the encrypted key to the device via the network to thereby activate the software application.

28. A computer medium as recited in claim 27, wherein execution of one or more sequences of pattern data by one or more processors causes the one or more processors to perform the additional steps of:
causing the software application to remove the key; and
checking whether a license of the removed key is valid; and
giving a credit back to a user of the device for removing the key.
